(19) United States
(12) Patent Application Publication
(10) Pub. No.: US 2019/0285424 A1
(43) Pub. Date: Sep. 19, 2019

(54) TRAVELING SUPPORT SYSTEM

(71) Applicant: Honda Motor Co., Ltd., Tokyo (JP)

(72) Inventors: Naoko Imai, Wako-shi (JP); Atsuyuki Suzuki, Wako-shi (JP); Tomoko Shintani, Wako-shi (JP)

(21) Appl. No.: 16/282,555

(22) Filed: Feb. 22, 2019

(30) Foreign Application Priority Data
Mar. 16, 2018 (JP) 2018-049831

(51) Int. Cl. G01C 21/34

(52) U.S. Cl. CPC G01C 21/3438; G01C 21/3453

(57) ABSTRACT

To provide a traveling support system which provides support for causing a vehicle which is moving to be reached by another vehicle, a delivery system including a function of the traveling support system includes a destination setting unit which sets a destination for a delivery vehicle to reach a vehicle based on a position of the vehicle recognized based on second vehicle position information, a reach route determination unit which determines, based on a position of the delivery vehicle recognized by a first vehicle position recognition unit, map information, and the destination, a reach route from the position of the delivery vehicle to the destination, and a reach route information notification unit which transmits reach route information representing the reach route to the delivery vehicle using a reach route information transmission unit and notifies the reach route information using a navigation device in the delivery vehicle.

### INCORPORATION BY REFERENCE

The present application claims priority under 35 U.S.C. § 119 to Japanese Patent Application No. 2018-049831 filed on Mar. 16, 2018. The content of the application is incorporated herein by reference in its entirety.

### BACKGROUND OF THE INVENTION

### Field of the Invention

The present invention relates to a traveling support system.

### Description of the Related Art

Conventionally, a delivery system adapted to deliver an article to be delivered to a receiving vehicle to enable delivery of the article to be delivered if a recipient is absent has been proposed (see, e.g., Japanese Patent Laid-Open No. 2006-206225). In the delivery system described in Japanese Patent Laid-Open No. 2006-206225, authentication information for unlocking a trunk of the receiving vehicle is previously registered in a delivery information server.

A deliverer performs communication with the receiving vehicle using a communication device provided in a delivery vehicle and performs authentication based on the authentication information, to unlock the trunk of the receiving vehicle. The deliverer accommodates the article to be delivered in the trunk of the receiving vehicle, to lock the trunk.

The delivery system described in Japanese Patent Laid-Open No. 2006-206225 enables a delivery to be completed by accommodating the article to be delivered in a vehicle parked at home even if the recipient is absent from home. However, when the deliverer has reached a delivery destination, the recipient may be out using the vehicle depending on a delivery timing. In this case, the delivery cannot be completed.

Therefore, if the recipient is out using the vehicle and the article to be delivered cannot be delivered to home, the article to be delivered can conceivably be delivered to the vehicle away from home. However, support needs to be provided such that the delivery vehicle can reach the vehicle at the delivery destination. Examples of a situation where the vehicle which is moving needs to be reached by another vehicle can conceivably include a case where a plurality of vehicles meet at an appropriate point on the way when used to go to a resort.

### SUMMARY OF THE INVENTION

The present invention has been made in view of the above-described background, and is directed to providing a traveling support system which provides support for causing a vehicle which is moving to be reached by another vehicle.

A traveling support system according to an aspect of the present invention includes a first vehicle position recognition unit which recognizes a position of a first vehicle, a second vehicle position recognition unit which recognizes a position or a movement schedule of a second vehicle, a map information acquisition unit which acquires map information, a destination setting unit which sets a destination for the first vehicle to reach the second vehicle based on the position or the movement schedule of the second vehicle recognized by the second vehicle position recognition unit, a reach route determination unit which determines, based on the position of the first vehicle recognized by the first vehicle position recognition unit, the map information, and the destination, a reach route from the position of the first vehicle to the destination, and a reach route information notification unit which notifies reach route information representing the reach route determined by the reach route determination unit using notification means provided in the first vehicle.

According to the aspect of the present invention, the second vehicle position recognition unit recognizes the position or the movement schedule of the second vehicle, and the first vehicle position recognition unit recognizes the position of the first vehicle. The destination setting unit sets the destination for the first vehicle to reach the second vehicle based on the position or the movement schedule of the second vehicle. The reach route information notification unit transmits the reach route information representing the reach route determined based on the position of the first vehicle, the map information, and the destination by the reach route determination unit to the first vehicle using a reach route information transmission unit. As a result, the reach of the first vehicle to the second vehicle can be supported by causing the first vehicle to travel according to the reach route.

The traveling support system may be configured to include an expected reach information transmission unit which transmits to the second vehicle expected reach information representing a time or a point at which the first vehicle is expected to reach the second vehicle when the first vehicle travels according to the reach route.

According to the configuration, when information about the expected time or the expected point at which the first vehicle reaches the second vehicle is provided to the second vehicle, the second vehicle can be forced to wait for the reach of the first vehicle by stopping traveling when the first vehicle has come close to the expected time or the expected point.

The traveling support system may be configured to include a waiting request transmission unit which transmits, when waiting request information, requesting to wait for a first predetermined time period, transmitted from the first vehicle is received, the waiting request information to the second vehicle.

According to the configuration, when the request to wait for the first predetermined time period from the first vehicle based on the waiting request information is transmitted to the second vehicle, the second vehicle can be forced to wait for the first predetermined time period to wait for the reach of the first vehicle.

The traveling support system may be configured to include a waitable time transmission unit which transmits, when waitable time information, indicating that a second predetermined time period can be waited for, transmitted from the second vehicle is received, the waitable time information to the first vehicle.

According to the configuration, when a notification that the second predetermined time period can be waited for from the second vehicle based on the waitable time information is transmitted to the first vehicle, the first vehicle can be requested to reach the second vehicle at a meeting point by setting a point which the first vehicle can reach within the second predetermined time period as the meeting point.

The traveling support system may be configured such that the destination setting unit sets, when the position of the second vehicle is unrecognizable by the second vehicle position recognition unit, a position of the second vehicle recognized immediately before by the second vehicle position recognition unit to the destination.

According to the configuration, even if the position of the second vehicle is unrecognizable by the second vehicle position recognition unit, when the position of the second vehicle acquired immediately before is set to the destination, the traveling of the first vehicle for reaching to second vehicle can be continued.

The traveling support system may be configured such that the destination setting unit extracts, when the position of the second vehicle is unrecognizable by the second vehicle position recognition unit, an expected traveling point of the second vehicle a position of which is assumed to become recognizable by the second vehicle position recognition unit based on the map information and sets the extracted expected traveling point to the destination.

According to the configuration, even if the position of the second vehicle is unacquirable by the second vehicle position recognition unit, when a point at which the position of the second vehicle is assumed to become acquirable is extracted from the map information and is set as the destination of the first vehicle, the traveling of the first vehicle for reaching the second vehicle can be continued.

The traveling support system may be configured to include a position unacquirable notification unit which transmits, when the position of the second vehicle is unrecognizable by the second vehicle position recognition unit, position unacquirable information notifying the second vehicle that the second vehicle is unrecognizable to the second vehicle.

According to the configuration, when the second vehicle is notified that the position of the second vehicle is unacquirable by the second vehicle position recognition unit based on the position unacquirable information, the second vehicle can be forced to move to a place where the position of the second vehicle is detectable.

### BRIEF DESCRIPTION OF THE DRAWINGS

FIG. 1 is an explanatory diagram illustrating a delivery form of an article to a moving vehicle using a delivery system;

FIG. 2 is a configuration diagram of the delivery system;

FIG. 3 is an explanatory diagram of processing for registering use of a delivery service provided by the delivery system and processing for changing a delivery destination;

FIG. 4 is an explanatory diagram of route determination processing to a vehicle at a delivery destination by the delivery system;

FIG. 5 is an explanatory diagram of processing for requesting the vehicle at the delivery destination to wait;

FIG. 6 is an explanatory diagram of processing for notifying a delivery vehicle of a waitable time period;

FIG. 7 is an explanatory diagram of a destination when the vehicle at the delivery destination travels in a tunnel:

FIG. 8 is an explanatory diagram of user registration information; and

FIG. 9 is an explanatory diagram of user delivery information.

### DETAILED DESCRIPTION OF THE PREFERRED EMBODIMENTS

### 1. Delivery Form Using Delivery System

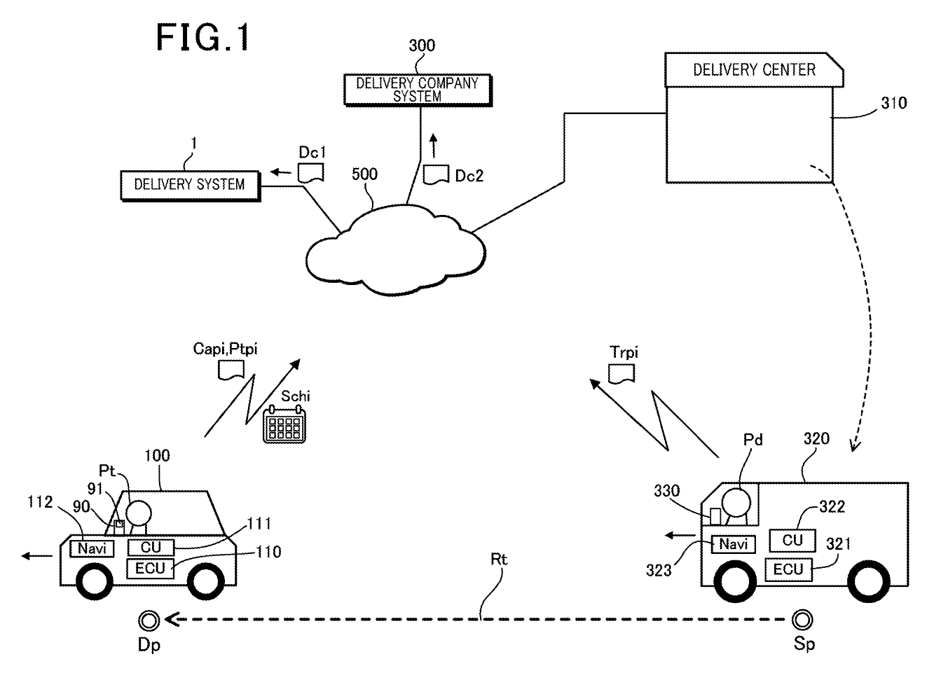

FIG. 1 illustrates a delivery form of an article to a vehicle using a delivery system in the present embodiment. Referring to FIG. 1, a delivery system 1 in the present embodiment performs processing for supporting a delivery to a home or a vehicle 100 of a user Pt. The delivery system 1 includes a function of a traveling support system according to the present invention.

The delivery system 1 is communicably connected to a user terminal 90 used by the user Pt, the vehicle 100 used by the user Pt (corresponding to a second vehicle in the present invention), a delivery company system 300, a delivery vehicle 320 (corresponding to a first vehicle in the present invention), and a deliverer terminal 330 used by a deliverer Pd via a communication network 500. The delivery company system 300 is communicably connected to a delivery center 310 and the deliverer terminal 330 used by the deliverer Pd via the communication network 500. Communication connection among communication elements may be wired connection or wireless connection. Examples of the user terminal 90 and the deliverer terminal 330 include a smartphone, a mobile phone, and a tablet terminal.

The vehicle 100 includes an ECU (electronic control unit) which controls an entire operation of the vehicle 100, a communication unit 111 which communicates with a vehicle exterior, and a navigation device 112 which receives a GPS (Global Positioning System) signal to detect a position of the vehicle 100 and refers to map information to guide a route to a destination. Similarly, the delivery vehicle 320 also includes an ECU 321 which controls an entire operation of the delivery vehicle 100, a communication unit 322 which communicates with the vehicle exterior, and a navigation device 323 which receives a GPS signal to detect a position of the delivery vehicle 320 and refers to map information to guide a route to a destination.

FIG. 1 illustrates a situation where an article to be delivered is delivered to the vehicle 100 when the user Pt who has previously registered use of a delivery service provided by the delivery system 1 is moving in the vehicle 100. The delivery system 1 registers schedule book information Schi of the user Pt transmitted from the user terminal 90. The delivery system 1 receives position information Ptpi of the user terminal 90 transmitted from the user terminal 90 and position information Capi of the vehicle 100 transmitted from the vehicle 100, to recognize a position of the user Pt and the position of the vehicle 100. Further, the delivery system 1 receives position information Trpi of the delivery vehicle 320 transmitted from the delivery vehicle 320.

The delivery system 1 sets a destination Dp for the delivery vehicle 320 to reach the vehicle 100 based on a position of the vehicle 100 which is moving, a movement schedule of the vehicle 100 recognized from the schedule book information Schi, or a movement schedule based on route information to the destination set in the navigation device 112 in the vehicle 100, for example.

The delivery system 1 determines a route (reach route) Rt from a position Sp of the delivery vehicle 320 to the destination Dp, and transmits information representing the reach route Rt to the navigation device 323 in the delivery vehicle 320 via the delivery company system 300 or directly. The deliverer Pd who drives the delivery vehicle 320 can deliver the article to be delivered to the user Pt by driving the delivery vehicle 320 according to a route guidance following the reach route Rt executed by the navigation device 323 to reach the vehicle 100.

When the delivery vehicle 320 has reached the vehicle 100, if the deliverer Pd cannot hand over the article to be delivered to the user Pt because the user Pt is away from the vehicle 100, the deliverer Pd operates the deliverer terminal 330 to unlock a door of the vehicle 100 using a virtual key and accommodates the article to be delivered within a vehicle interior. The virtual key is transmitted to the deliverer terminal 330 via the delivery company system 300 from the delivery system 1. The deliverer Pd locks the door of the vehicle 100 using the virtual key, to complete the delivery to the vehicle 100.

### 2. Configuration of Delivery System

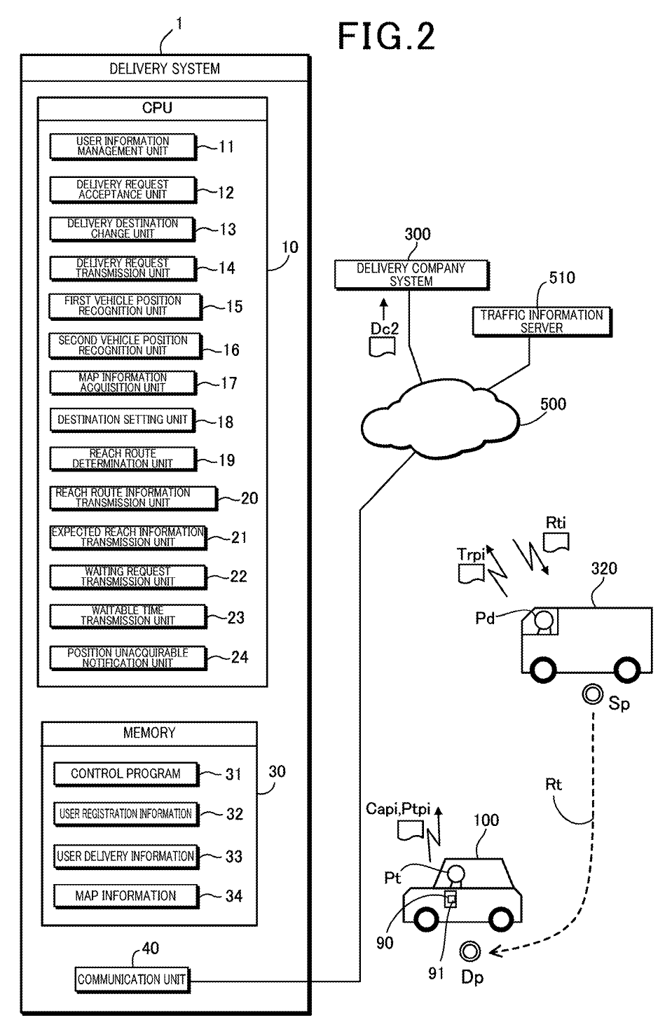

FIG. 2 is a configuration diagram of the delivery system 1. Referring to FIG. 2, the delivery system 1 is a computer system including a CPU (central processing unit) 10, a memory 30, a communication unit 40, various types of interface circuits (not illustrated), and the like. The CPU 10 reads and executes a control program 31 in the delivery system 1 stored in the memory 30, to function as a user information management unit 11, a delivery request acceptance unit 12, a delivery destination change unit 13, a delivery request transmission unit 14, a first vehicle position recognition unit 15, a second vehicle position recognition unit 16, a map information acquisition unit 17, a destination setting unit 18, a reach route determination unit 19, a reach route information transmission unit 20, an expected reach information transmission unit 21, a waiting request transmission unit 22, a waitable time transmission unit 23, and a position unacquirable notification unit 24.

The memory 30 stores user registration information 32 in which information about each of users who have registered use of the delivery service using the delivery system 1 is recorded, user delivery information 33 in which scheduled delivery information for each of the users is recorded, map information 34, and the like, in addition to the control program 31.

The user information management unit 11 is responsive to a registration operation performed by each of the users to receive information about the user (a name, information about a vehicle to be used, etc.) transmitted from a terminal of the user and issue a user ID (identification) as identification information of the user. The user information management unit 11 provides, when an article is delivered to a vehicle of each of the users, information about a virtual key for guest for unlocking a door of the vehicle. The information about the virtual key for guest is stored in the vehicle of each of the users. Accordingly, authentication using the virtual key for guest is performed so that the door of the vehicle at a delivery destination can be unlocked and locked.

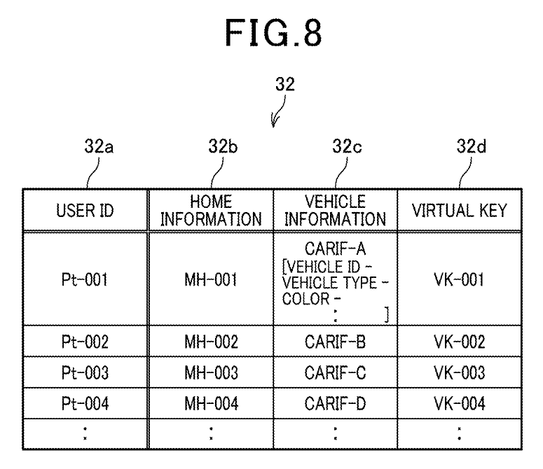

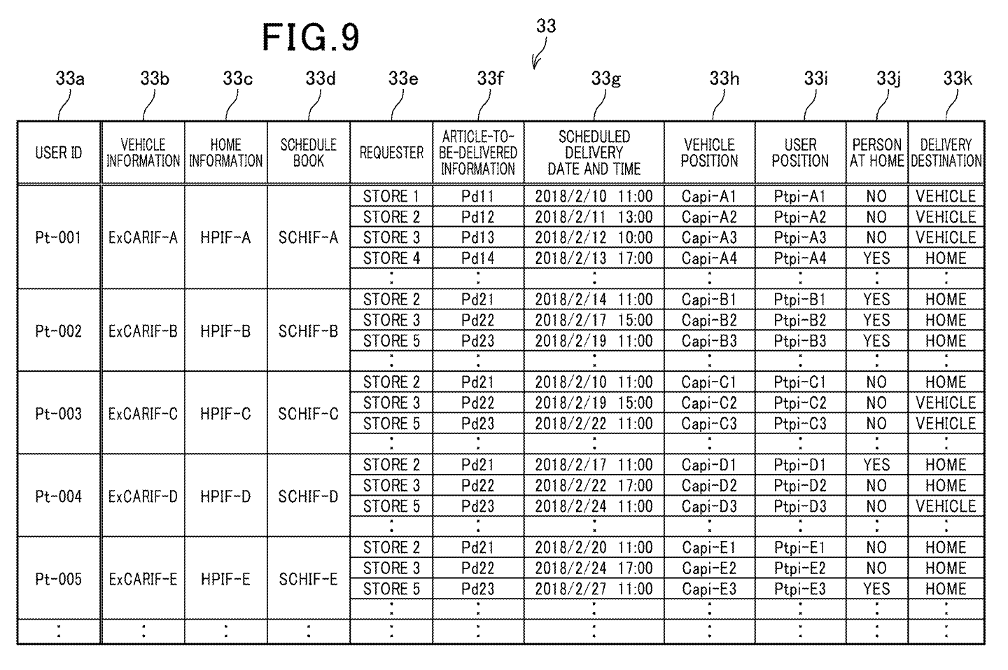

As illustrated in FIG. 8, home information 32b, vehicle information 32c, and a virtual key 32d of each of the users who have registered use of the delivery service using the delivery system 1 are recorded in the user registration information 32 to correspond to a user ID 32a of the user. As illustrated in FIG. 9, vehicle information 33b, home information 33c, an schedule book 33d, a requester 33e, article-to-be-delivered information 33f, a scheduled delivery date and time 33g, a vehicle position 33h, a user position 33i, a person at home 33j, and a delivery destination 33k are recorded in the user delivery information 33 to correspond to the user ID of each of the users.

The delivery request acceptance unit 12 is responsive to an operation of a user terminal or a store terminal provided in a store, for example, to receive first delivery request information Dc1 transmitted from the terminal and thus accept a request to deliver the article to the user Pt. Information about an article to be delivered, a delivery destination, and the like included in the first delivery request information Dc1 are recorded in the user delivery information 33 by the user information management unit 11.

The delivery destination change unit 13 determines whether or not the user Pt is present at home at a scheduled delivery date and time based on the schedule book 33d, the scheduled delivery date and time 33g of each article to be delivered, and the like recorded in the user delivery information 33. When the user Pt is absent from home, the delivery destination 33k is changed from the home to the vehicle 100 under a predetermined condition. The delivery request transmission unit 14 transmits to the delivery company system 300 second delivery request information Dc2 indicating that the home or the vehicle 100 of the user Pt is designated as the delivery destination 33k.

The first vehicle position recognition unit 15 receives the position information Trpi of the delivery vehicle 320 transmitted from the delivery vehicle 320, and recognizes the position of the delivery vehicle 320 form the position information Trpi. The second vehicle position recognition unit 16 receives the position information Capi of the vehicle 100 transmitted from the vehicle 100, and recognizes the position of the vehicle 100 from the position information Capi. The second vehicle position recognition unit 16 also recognizes the movement schedule of the vehicle 100 based on the schedule book 33d recorded in the user delivery information 33, for example. The map information acquisition unit 17 reads out and acquires the map information 34 stored in the memory 30. Note that the map information acquisition unit 17 may be configured to acquire map information from an external traffic information server 510 via the communication network 500.

The destination setting unit 18 sets the destination Dp for the delivery vehicle 320 to reach the vehicle 100 when the delivery destination 33k designated based on the second delivery request information Dc2 is the vehicle 100 and the vehicle 100 is moving. The time when the vehicle 100 is moving means that the vehicle 100 is heading for a movement destination, and includes a situation where the vehicle 100 is traveling and a situation where the vehicle 100 is stopped for a break, for example, on the way.

The reach route determination unit 19 determines the reach route Rt as a reach route from the position Sp (a departure place) of the delivery vehicle 320 recognized by the first vehicle position recognition unit 15 to the destination Dp set by the destination setting unit 18 by referring to the map information 34. The reach route information transmission unit 20 transmits to the delivery company system 300 reach route information Rti including information about the reach route Rt.

The delivery company system 300 transmits the reach route information Rti to the delivery vehicle 320. The navigation device 323 (see FIG. 1) in the delivery vehicle 320 performs a route guidance following the reach route Rt using guidance display on a display unit (corresponding to notification means in the present invention) not illustrated and output of a guidance voice from a speaker (corresponding to notification means in the present invention) not illustrated, and the deliverer Pd who drives the delivery vehicle 320 drives the delivery vehicle 320 according to the route guidance. As a result, the delivery vehicle 320 can efficiently reach the vehicle 100. When the reach route information transmission unit 20 transmits the reach route information Rti to the delivery vehicle 320 via the delivery company system 300, a configuration in which the navigation device 323 in the delivery vehicle 320 notifies the information about the reach route Rt corresponds to a reach route information notification unit in the present invention.

The expected reach information transmission unit 21 estimates a time and a point expected for the delivery vehicle 320 to reach the vehicle 100 based on a traveling distance by the reach route Rt, a regulation speed, traffic information (congestion information, accident information, etc.) of the reach route Rt acquired from the traffic information server 510, presence or absence of another delivery on the way, and the like. Expected reach information representing the estimated time and point is transmitted to the vehicle 100. Note that expected reach information representing either one of the estimated time and point may be transmitted to the vehicle 100.

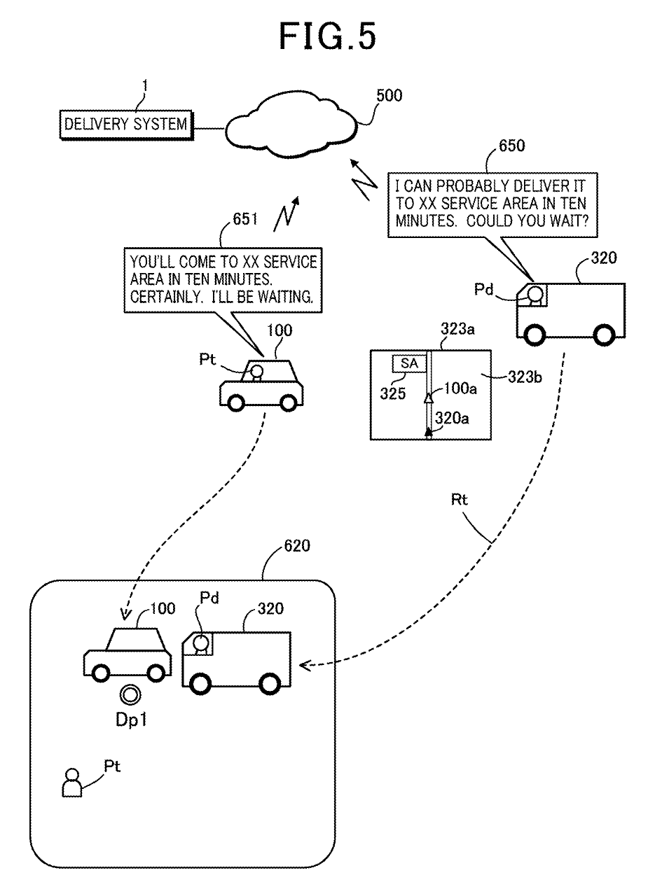

The waiting request transmission unit 22 transmits, when it receives from the delivery vehicle 320 waiting request information for requesting the vehicle 100 to wait for a first predetermined time period, the waiting request information to the vehicle 100. FIG. 5 illustrates a situation where the vehicle 100 and the delivery vehicle 320 are coming close to a parking area 620 (e.g., a service area provided in an expressway).

A map 323b in the vicinity of the reach route Rt is displayed on the display 323a in the navigation device 323 provided in the delivery vehicle 320, and a parking area 325 (a service area, etc.) in the vicinity of the reach route Rt, a position 100a of the vehicle 100, and a position 320a of the delivery vehicle 320 are displayed on the map 323b. Note that the position information of the vehicle 100 is transmitted to the delivery vehicle 320 via the delivery company system 300 from the delivery system 1 or directly from the delivery system 1. The navigation device 323 displays the position 100a of the vehicle 100 on the map 323b based on the position information.

The deliverer Pd visually recognizes the display 323a, and transmits, when it recognizes that both the vehicle 100 and the delivery vehicle 320 are getting close to the parking area 325, waiting request information 650 to the delivery system 1. The waiting request information 650 has a content requesting the vehicle 100 to wait for ten minutes (corresponding to a first predetermined time period in the present invention) using a message “I can probably deliver it to XX service area (a parking area 620) in ten minutes. Could you wait?”.

The waiting request transmission unit 22 transmits to the vehicle 100 the waiting request information 650 received from the delivery vehicle 320. The waiting request transmission unit 22 transmits, when it receives response information 651 from the vehicle 100 which has received the waiting request information 650, the response information 651 to the delivery vehicle 320. In an example illustrated in FIG. 5, the response information 651 has a content receiving a waiting request using a message “You'll come to XX service area in ten minutes. Certainly. I'll be waiting”.

Therefore, the deliverer Pd who has confirmed the content of the response information 651 recognizes that the article to be delivered can be delivered to the vehicle 100 in the parking area 620. The destination setting unit 18 sets the parking area 620 to a destination, and sets the position of the vehicle 100 recognized by the second vehicle position recognition unit 16 to a destination when it is recognized that the vehicle 100 is parked in the parking area 620 from the position of the vehicle 100.

The reach route determination unit 19 determines the reach route Rt using a position Sp2 of the delivery vehicle 320 recognized by the first vehicle position recognition unit 15 as a departure place and using a position Dp2 of the vehicle 100 within the parking area 620 as a destination. Reach route information representing the reach route Rt is transmitted to the delivery vehicle 320 by the reach route information transmission unit 20, and a route guidance to a parking position of the vehicle 100 is performed by the navigation device 323.

As a result, the deliverer Pd can deliver the article to be delivered to the vehicle 100 waiting in the parking area 620 by causing the delivery vehicle 320 to reach the vehicle 100. In this case, even if the user Pt is away from the vehicle 100 for a break, the deliverer Pd can accommodate the article to be delivered in a luggage room or the like in the vehicle 100 by unlocking the door of the vehicle 100 using the virtual key, to complete a delivery.

After the delivery is completed, a delivery completion notification may be transmitted to the user terminal 90 from the deliverer terminal 330. According to such a configuration, even if the user Pt is away from the vehicle 100 for a break, the user Pt can confirm the delivery completion notification using the user terminal 90 and recognize that the delivery is completed.

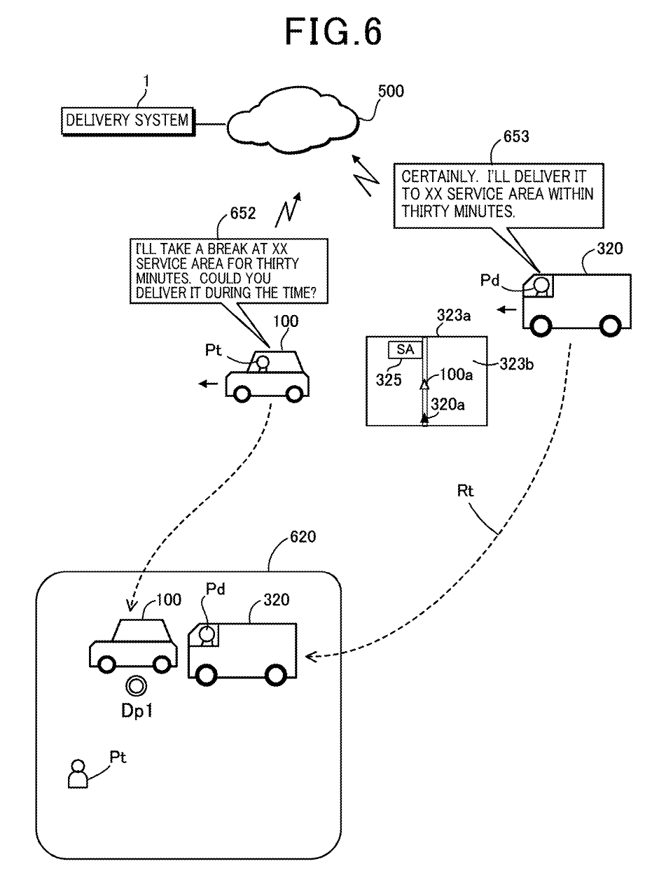

The waitable time transmission unit 23 transmits, when it receives from the vehicle 100 waitable time information notifying the delivery vehicle 320 that the second predetermined time period can be waited for, the waitable time information to the delivery vehicle 320. FIG. 6 illustrates a situation where the vehicle 100 and the delivery vehicle 320 are getting close to the parking area 620, like FIG. 5.

The user Pt of the vehicle 100 transmits waitable time information 652 to the delivery system 1 when he/she will stop the vehicle 100 in the parking area 620 to take a break. The waitable time information 652 has a content notifying a waitable time using a message “I'll take a break in XX service area (the parking area 620) for thirty minutes. Could you deliver it during the time?”.

The waitable time transmission unit 23 transmits the waitable time information 652 received from the vehicle 100 to the delivery vehicle 320. The deliverer Pd in the delivery vehicle 320 confirms the display 323a in the navigation device 323, and determines whether or not the article to be delivered can be delivered to the parking area 620 within 30 minutes. The deliverer Pd transmits to the delivery system 1 response information 653 notifying a delivery result.

In an example illustrated in FIG. 6, the response information 653 has a content notifying that a delivery is performed using a message “Certainly. I'll come to deliver it in XX service area within 30 minutes”. The delivery system 1 transmits the response information 653 to the vehicle 100, and the user Pt who has confirmed the response information 653 can wait for the delivery in the parking area 620.

The destination setting unit 18 sets the position Dp1 of the vehicle 100 parked in the parking area 620 to the destination, like in the case illustrated in FIG. 5. The reach route determination unit 19 determines the reach route Rt to the position Dp2, and the reach route information transmission unit 20 transmits reach route information to the delivery vehicle 320. Accordingly, the deliverer Pd can deliver the article to be delivered to the vehicle 100 by causing the delivery vehicle 320 to reach the vehicle 100 waiting in the parking area 620.

The position unacquirable notification unit 24 transmits, when the position of the vehicle 100 becomes unacquirable by the second vehicle position recognition unit 16, position unacquirable information notifying that the position is unacquirable to the vehicle 100. As a result, the user Pt of the vehicle 100 can be forced to move the vehicle 100 to a place where the position is acquirable. A case where the position of the vehicle 100 is unacquirable corresponds to a case where the vehicle 100 is parked in a multistory car park and a GPS signal is unreceivable, for example.

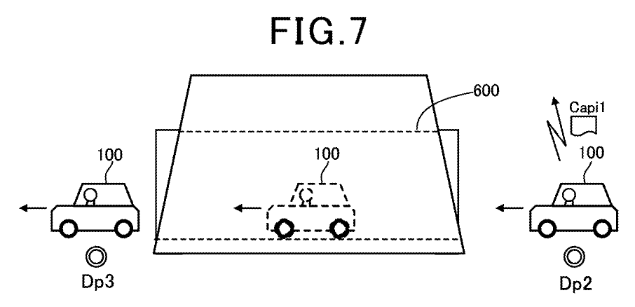

As illustrated in FIG. 7, while the vehicle 100 is traveling in a tunnel 600, the GPS signal cannot be received. Thus, transmission of the vehicle position information Capi from the vehicle 100 is stopped, and the second vehicle position recognition unit 16 cannot recognize the position of the vehicle 100. The destination setting unit 18 sets a position Dp1 of the vehicle 100 in the vicinity of an entrance of the tunnel 600 acquired immediately before to a destination while the position of the vehicle 100 is unrecognizable by the second vehicle position recognition unit 16. If position information about a point Dp3 of the vehicle 100, which has passed through the tunnel 600, can be acquired from the map information 34, the destination setting unit 18 may extract Dp3 as an expected traveling point of the vehicle 100 and set the extracted Dp3 to a destination.

### 3. Processing from User Registration to Delivery Instruction

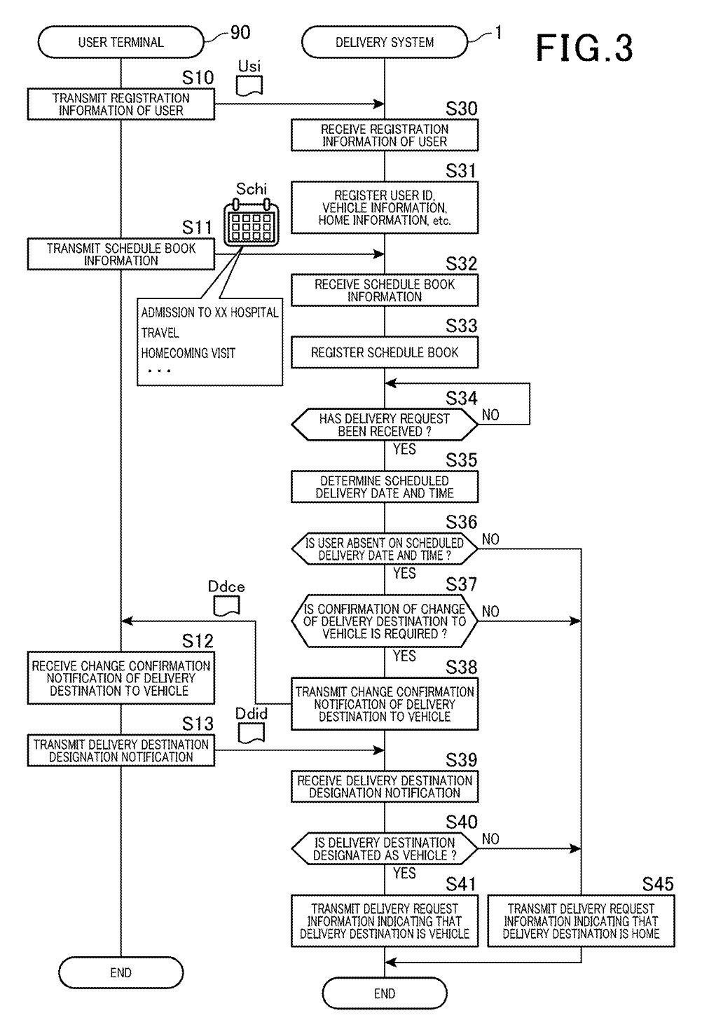

A series of processing performed by the delivery system 1 and the user terminal 90 in a process of performing a delivery to the vehicle 100 of the user Pt illustrated in FIG. 1 will be described below according to a flowchart illustrated in FIG. 3.

The user Pt browses a web page provided by the delivery system 1 using the user terminal 90 and inputs information required for registration on a registration application screen to use the delivery service provided by the delivery system 1. The user terminal 90 transmits registration information Usi inputted by the user Pt to the delivery system 1 in step S10 illustrated in FIG. 3. The registration information Usi includes a user ID issued by the delivery system 1, home information, information about the vehicle 100 (a vehicle ID for communication, a vehicle type, a color, etc.) used by the user Pt, and a virtual key of the vehicle 100, and the like.

The home information includes information such as a position of a home (a latitude, a longitude, or an address) and presence or absence of a roommate. The vehicle ID for communication includes identification information (a BLE (Bluetooth Low Energy) authentication code, etc.) for performing short-distance communication with the communication unit 102 in the vehicle 100 and identification information (an IP (Internet Protocol) address, etc.) for performing communication with the vehicle 100 via the communication network 500. In step S30, the delivery system 1 receives the registration information Usi of the user Pt. In subsequent step S31, the user information management unit 11 in the delivery system 1 registers the user ID, the home information, the vehicle information, and the virtual key acquired from the registration information Usi in the user registration information 32.

The user Pt performs an operation for registering a schedule book app used at the user terminal 90 in the delivery system 1. In step S11, the user terminal 90 transmits the schedule book information Schi to the delivery system 1 in response to the operation. The user Pt inputs his/her own schedule in a schedule book, as needed, and the schedule book app transmits, when the schedule book information Schi is changed by adding a schedule to the schedule book or changing a schedule in the schedule book, the changed schedule book information Schi to the delivery system 1.

The user information management unit 11 in the delivery system 1 receives the schedule book information Schi in step S32, and then registers the schedule book of the user Pt represented by the schedule book information Schi in the user delivery information 33 in subsequent step S33. Then, the user information management unit 11 updates the schedule book registered in the user delivery information 33 every time it receives the schedule book information Schi obtained by adding or correcting the schedule from the user terminal 90.

Subsequent step S34 is processing by the delivery request acceptance unit 12. When the delivery request acceptance unit 12 receives delivery request information transmitted from the user terminal 90, a store terminal, or the like, the processing proceeds to step S35. In step S35, the user information management unit 11 determines a scheduled delivery date and time based on a delivery destination, article-to-be-delivered information, a preferred delivery date, a scheduled delivery date and time of another article to be delivered, and the like designated based on delivery request information. The user information management unit 11 registers the article-to-be-delivered information and the scheduled delivery date and time in the user delivery information 33.

Subsequent steps S36 to S39 are each processing performed by the delivery destination change unit 13. In step S36, the delivery destination change unit 13 refers to the schedule book of the user Pt registered in the user delivery information 33, and determines whether or not the user Pt is absent from home on the scheduled delivery date.

If the delivery destination change unit 13 determines that the user Pt is absent from home on the scheduled delivery date, the processing proceeds to step S37. If the delivery destination change unit 13 determines that the user Pt is present at home, the processing proceeds to step S45.

When it is assumed that the user Pt is absent from home at the scheduled delivery date and time in step S37, the delivery destination change unit 13 determines whether or not the user Pt needs to confirm whether or not the delivery destination is changed from the home to the vehicle 100. In the present embodiment, when at least any one of first to fifth conditions, described below, holds, the delivery destination change unit 13 does not unconditionally change the delivery destination from the home to the vehicle 100 but determines that the user Pt confirms whether or not the delivery destination is changed from the home to the vehicle 100.

First condition . . . A distance between the position of the vehicle 100 recognized by the second vehicle position recognition unit 16 and the position of the user Pt recognized from the user position information Ptpi is a first predetermined distance (e.g., several meters) or less.

Second condition . . . A distance between the position of the vehicle 100 recognized by the second vehicle position recognition unit 16 and the position of the user Pt recognized from the user position information Ptpi is a second predetermined distance (e.g., several kilometers) or more.

Third condition . . . The type of the article to be delivered is food required to be stored frozen or refrigerated.

Fourth condition . . . The type of the article to be delivered is a product assumed to be used at home, like a large-sized home electrical appliance.

Fifth condition . . . A roommate is present at home.

When the first condition holds, it is assumed that the user Pt is in the vehicle 100 or immediately gets into the vehicle 100 and moves in the vehicle 100. Therefore, when the delivery vehicle 320 reaches the delivery destination, the vehicle 100 has already moved to another place so that the article may be undeliverable.

When the second condition holds, it is assumed that the user Pt is significantly far away from the vehicle 100 and does not return to the vehicle 100. Therefore, it is considered that there are few merits of hurrying to deliver the article to the vehicle 100.

When the third condition holds, even if the food required to be stored frozen or refrigerated is delivered to the vehicle 100, the food cannot be stored in the vehicle 100. Accordingly, the food may be deteriorated.

When the fourth condition holds, even if the large-sized home electrical appliance is delivered to the vehicle 100, the home electrical appliance is not used until the user Pt returns home. Accordingly, it is considered that there are few merits of hurrying to deliver the home electrical appliance.

When the fifth condition holds, if the article to be delivered is an article (a cosmetic, etc.) personally used by the user Pt and is immediately required, for example, the article cannot be used by the user Pt even if received by the roommate at home. Thus, it is considered that a delivery of the article to be delivered to the vehicle 100 meets a need of the user Pt.

In step S38, the delivery destination change unit 13 transmits to the user terminal 90 a change confirmation notification Ddce inquiring whether or not the delivery destination is changed from the home to the vehicle 100. The change confirmation notification Ddce has a content in which the condition, which holds among the above-described first to fifth conditions, is presented to ask the user Pt for confirmation as to whether or not the delivery destination is changed from the home to the vehicle 100.

In step S12, the user Pt performs an operation for confirming the content of the change confirmation notification Ddce and designating the delivery destination using the user terminal 90. In step S13, the user terminal 90 transmits to the delivery system 1 delivery destination change instruction information Ddid for designating the delivery destination in response to the operation.

The delivery destination change unit 13 receives the delivery destination change instruction information Ddid in step S39, and then determines whether or not the delivery destination is designated as the vehicle 100 in subsequent step S40. The processing proceeds to step S41 when the delivery destination change unit 13 determines that the delivery destination is designated as the vehicle 100, and proceeds to step S45 when the delivery destination change unit 13 determines that the delivery destination is designated as the home.

In step S41, the delivery request transmission unit 14 in the delivery system 1 transmits to the delivery company system 300 delivery request information indicating that the delivery destination has been changed from the home to the vehicle 100. As a result, the article to be delivered is delivered to the vehicle 100 of the user Pt by the delivery vehicle 320, as illustrated in FIG. 1. In step S45, the delivery request transmission unit 14 transmits to the delivery company system 300 the delivery request information indicating that the delivery destination is unchanged from the home. As a result, the article to be delivered is delivered to the home of the user Pt. Note that when the delivery destination is designated as the vehicle 100 at the time of a delivery request, the delivery destination change unit 13 does not change the delivery destination, and the delivery request transmission unit 14 transmits to the delivery company system 300 the delivery request information indicating that the delivery destination has been changed to the vehicle 100.

### 4. Processing for Determining Reach Route to Vehicle at Delivery Destination

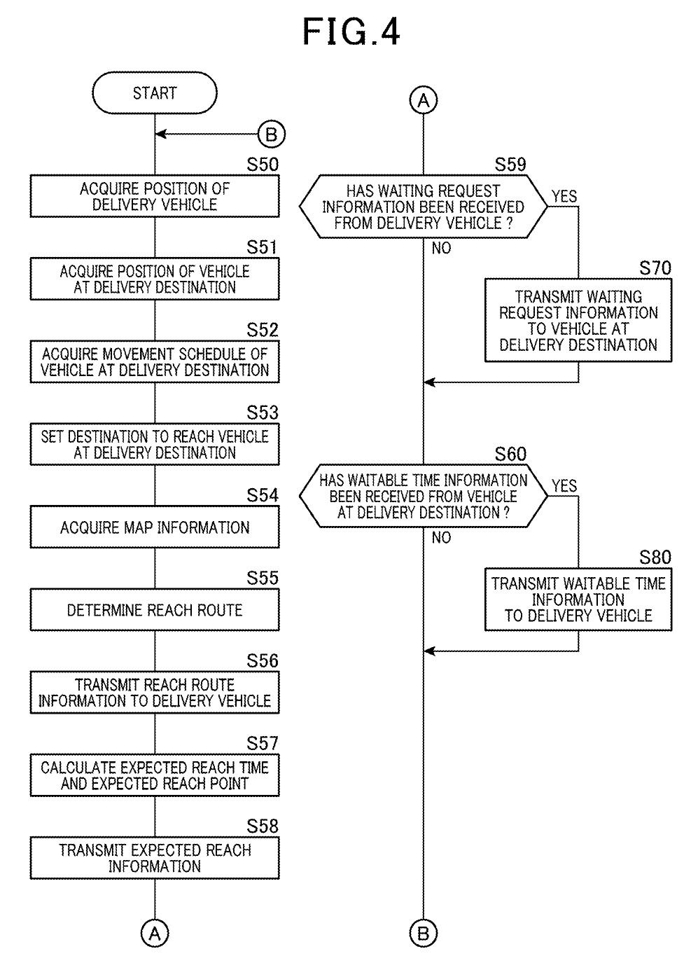

Then, processing for setting a reach route performed when a delivery is performed using the vehicle 100 which is moving as a delivery destination will be described according to a flowchart illustrated in FIG. 4.

Step S50 illustrated in FIG. 4 is processing performed by the first vehicle position recognition unit 15. The first vehicle position recognition unit 15 receives position information Capi of the delivery vehicle 320 transmitted from the delivery vehicle 320, and recognizes the position of the delivery vehicle 320 based on the position information Capi. Subsequent step S51 is processing performed by the second vehicle position recognition unit 16. The second vehicle position recognition unit 16 receives the position information Capi of the vehicle 100 transmitted from the vehicle 100, and recognizes the position of the vehicle 100 based on the position information Capi. In step S52, the second vehicle position recognition unit 16 refers to the schedule book 33d in the user delivery information 33, and recognizes the movement schedule of the vehicle 100 when the user Pt uses the vehicle 100 to go out.

Subsequent step S53 is processing performed by the destination setting unit 18. The destination setting unit 18 basically sets the position of the vehicle 100 recognized by the second vehicle position recognition unit 16 to a destination. As described above with reference to FIG. 5 and FIG. 6, the destination setting unit 18 sets, when the vehicle 100 is caused to wait in the parking area 620, for example, and a delivery is performed to a waiting position, the waiting position to a destination while the vehicle 100 reaches the waiting position.

As described above with reference to FIG. 7, if the position of the vehicle 100 is unacquirable by the second vehicle position recognition unit 16, a position Dp1 of the vehicle 100 acquired immediately before the position of the vehicle 100 becomes unacquirable or a position Dp2, at which the position of the vehicle 100 becomes acquirable, recognized from the map information 34 is set to a destination.

Subsequent step S54 is processing performed by the map information acquisition unit 17. The map information acquisition unit 17 reads and acquires the map information 34 stored in the memory 30. Subsequent step S55 is processing performed by the reach route determination unit 19. The reach route determination unit 19 determines the reach route Rt as a reach route until the delivery vehicle 320 reaches the destination set by the destination setting unit 18 using the position of the delivery vehicle 320 as a departure place by referring to the map information 34.

Subsequent step S56 is processing performed by the reach route information transmission unit 20. The reach route information transmission unit 20 transmits to the delivery vehicle 320 reach route information representing the reach route Rt determined by the reach route determination unit 19. Subsequent steps S57 and S58 are each processing performed by the expected reach information transmission unit 21. In step S57, the expected reach information transmission unit 21 estimates, when the delivery vehicle 320 travels according to the reach route Rt, a time or a place at which the delivery vehicle 320 is expected to reach the vehicle 100 in step S40. In step S58, the expected reach information transmission unit 21 transmits to the vehicle 100 expected reach information representing the estimated expected time or place.

Subsequent step S59 and step S70 branched from step S59 are each processing performed by the waiting request transmission unit 22. In step S59, the waiting request transmission unit 22 determines whether or not it has received waiting request information from the delivery vehicle 320. The processing proceeds to step S70 when the waiting request transmission unit 22 receives the waiting request information, and proceeds to step S60 when the waiting request transmission unit 22 does not receive the waiting request information. In step S70, the waiting request transmission unit 22 transmits the waiting request information 650 to the delivery system 1, as described with reference to FIG. 5, and the processing proceeds to step S60.

Step S60 and step S80 branched from step S60 are each processing performed by the waitable time transmission unit 23. In step S60, the waitable time transmission unit 23 determines whether or not it has received waitable time information from the vehicle 100. The processing proceeds to step S80 when the waitable time transmission unit 23 receives the waitable time information, and proceeds to step S50 when the waitable time transmission unit 23 does not receive the waitable time information. In step S80, the waitable time transmission unit 23 transmits the waitable time information 652 to the delivery vehicle 320, as described with reference to FIG. 6, and the processing proceeds to step S50.

The processing according to the flowchart illustrated in FIG. 4 is repeatedly performed until the delivery vehicle 320 reaches the vehicle 100 to complete the delivery. The reach route determination unit 19 updates the reach route Rt, as needed, depending on the movement of the vehicle 100. Therefore, the deliverer Pd of the delivery vehicle 320 causes the delivery vehicle 320 to travel according to the reach route Rt, to enable the delivery vehicle 320 to reliably reach the vehicle 100 which is moving.

### 4. Another Embodiment

Although the reach route determination unit 9 provided in the delivery system 1 determines the reach route to the destination for the delivery vehicle 320 (a first vehicle) to reach the vehicle 100 (a second vehicle) in the above-described embodiment, a reach route determination unit may be provided in a navigation device 323 in a delivery vehicle 320 or a deliverer terminal 330 possessed by a deliverer Pd who drives the delivery vehicle 320. In this case, the reach route determination unit provided in the navigation device 323 or the deliverer terminal 330 receives information about a current position of a vehicle 100 from an information provision server such as a delivery system 1, and determines a reach route to a destination to reach the vehicle 100. The navigation device 323 is provided with a reach route information notification unit which notifies reach route information representing the reach route determined by the reach route determination unit using a display unit or a speaker in the navigation device 323. The deliverer terminal 330 is provided with a reach route information notification unit which notifies the information representing the reach route determined by the reach route determination unit using a display unit or a speaker in the deliverer terminal 330.

Although an example in which the delivery vehicle 320 is caused to reach the vehicle 100 to deliver the article to be delivered to the vehicle 100 has been illustrated in the above-described embodiment, an example of application of the present invention is not limited to this. The present invention is applicable to applications for causing, among a plurality of vehicles, the certain vehicle to be reached by the other vehicle. When a plurality of vehicles head for a common destination from respective different places, for example, meeting of the plurality of vehicles at an appropriate place on the way of movement can be supported according to the present invention.

Although an expected reach information transmission unit 21 is provided to transmit to the vehicle 100 expected reach information representing an expected time or an expected point at which the delivery vehicle 320 reaches the vehicle 100 in the above-described embodiment, the expected reach information transmission unit 21 may be omitted.

Although a waiting request transmission unit 22 is provided to notify the vehicle 100 of a waiting request from the delivery vehicle 320 in the above-described embodiment, the waiting request transmission unit 22 may be omitted.

Although a waitable time transmission unit 23 is provided to transmit a waitable time notification from the vehicle 100 to the delivery vehicle 320 in the above-described embodiment, the waitable time transmission unit 23 may be omitted.

Although a position unacquirable notification unit 24 is provided to notify, when position information of the vehicle 100 is unacquirable by a second vehicle position recognition unit 16, the vehicle 100 that the position information is unacquirable in the above-described embodiment, the position unacquirable notification unit 24 may be omitted.

Although, when the position of the vehicle 100 is unacquirable by the second vehicle position recognition unit 16, a position of the vehicle 100 recognized immediately before or a place where the position is assumed to become recognizable is set as a destination of the reach route in the above-described embodiment, a configuration corresponding to the time when the position of the vehicle 100 is thus unrecognizable may be omitted.

Note that FIGS. 2 and 4 are schematic views illustrating a functional configuration of the delivery system 1 and the vehicle 100 while sectionalizing the functional configuration depending on a main processing content to facilitate understanding of the present invention. A configuration of the delivery system 1 and the vehicle 100 may be configured by another sectionalization. Processing of each of components may be performed by one hardware unit, or may be performed by a plurality of hardware units. Processing of each of the components may be performed by one program, or may be performed by a plurality of programs.

### REFERENCE SIGNS LIST

1 . . . Delivery system, 10 . . . CPU, 11 . . . User information management unit, 12 . . . Delivery request acceptance unit, 13 . . . Delivery destination change unit, 14 . . . Delivery request transmission unit, 15 . . . First vehicle position recognition unit, 16 . . . Second vehicle position recognition unit, 17 . . . Map information acquisition unit, 18 . . . Destination setting unit, 19 . . . Reach route determination unit, 20 . . . Reach route information transmission unit, 21 . . . Expected reach information transmission unit, 22 . . . Waiting request transmission unit, 23 . . . Waitable time transmission unit, 24 . . . Position unacquirable notification unit, 30 . . . Memory, 31 . . . Control program, 32 . . . User registration information, 33 . . . User delivery information, 34 . . . Map information, 40 . . . Communication unit, 90 . . . User terminal, 100 . . . Vehicle (second vehicle), 300 . . . Delivery company system, 310 . . . Delivery center, and 320 . . . Delivery vehicle (first vehicle).

What is claimed is:

1. A traveling support system comprising:
a first vehicle position recognition unit which recognizes a position of a first vehicle;
a second vehicle position recognition unit which recognizes a position or a movement schedule of a second vehicle;
a map information acquisition unit which acquires map information;
a destination setting unit which sets a destination for the first vehicle to reach the second vehicle based on the position or the movement schedule of the second vehicle recognized by the second vehicle position recognition unit;
a reach route determination unit which determines, based on the position of the first vehicle recognized by the first vehicle position recognition unit, the map information, and the destination, a reach route from the position of the first vehicle to the destination; and
a reach route information notification unit which notifies reach route information representing the reach route determined by the reach route determination unit using notification means provided in the first vehicle.

2. The traveling support system according to claim 1, further comprising an expected reach information transmission unit which transmits to the second vehicle expected reach information representing a time or a point at which the first vehicle is expected to reach the second vehicle when the first vehicle travels according to the reach route.

3. The traveling support system according to claim 1, further comprising a waiting request transmission unit which transmits, when waiting request information, requesting to wait for a first predetermined time period, transmitted from the first vehicle is received, the waiting request information to the second vehicle.

4. The traveling support system according to claim 1, further comprising a waitable time transmission unit which transmits, when waitable time information, indicating that a second predetermined time period can be waited for, transmitted from the second vehicle is received, the waitable time information to the first vehicle.

5. The traveling support system according to claim 1, wherein the destination setting unit sets, when the position of the second vehicle is unrecognizable by the second vehicle position recognition unit, a position of the second vehicle recognized immediately before by the second vehicle position recognition unit to the destination.

6. The traveling support system according to claim 1, wherein the destination setting unit extracts, when the position of the second vehicle is unrecognizable by the second vehicle position recognition unit, an expected traveling point of the second vehicle a position of which is assumed to become recognizable by the second vehicle position recognition unit based on the map information and sets the extracted expected traveling point to the destination.

7. The traveling support system according to claim 1, further comprising a position unacquirable notification unit which transmits, when the position of the second vehicle is unrecognizable by the second vehicle position recognition unit, position unacquirable information notifying the second vehicle that the second vehicle is unrecognizable to the second vehicle.
